(19) United States
(12) Patent Application Publication
(10) Pub. No.: US 2011/0026716 A1
(43) Pub. Date: Feb. 3, 2011

(54) Method And System For On-Screen Authentication Using Secret Visual Message

(76) Inventors: Weng Sing Tang, Singapore (SG); Pern Chern Lee, Singapore (SG); Arief Nuradi, Singapore (ID)

Correspondence Address: JACOBSON HOLMAN PLLC, 400 SEVENTH STREET N.W., SUITE 600, WASHINGTON, DC, 20004, US

(21) Appl. No.: 12/936,548

(22) PCT Filed: May 4, 2009
(86) PCT No.: PCT/SG09/00159

§ 371 Date: Oct. 6, 2010

(30) Foreign Application Priority Data
May 2, 2008 (SG) 200803412-6
Jul. 9, 2008 (SG) 200805166-6

(51) Int. Cl. H04L 9/30; H04L 9/22; G06F 3/048; G09G 3/36

(52) U.S. Cl. 380/284; 380/46; 715/781; 345/87

(57) ABSTRACT

A method of authenticating a user includes providing a user key to an authentication authority, providing a transmission message from the authentication authority in response to the user key, providing a secret message using the transmission message, displaying the secret message to the user using a display screen, and providing a user response to the authentication authority in response to the user observing the secret message.

### FIELD OF THE INVENTION

The present invention relates generally to authentication or verification of a person's identity for security purposes, and more particularly to a method for on-screen authentication using a secret visual message.

### BACKGROUND

An authentication factor is used to authenticate or verify a person's identity for security purposes. Two-factor authentication uses two different factors to authenticate the person. Using two factors as opposed to one delivers a higher level of authentication assurance. Using more than one factor is referred to as strong authentication.

Currently, two-factor authentication can be achieved in several ways:
1) Biometric—Using the unique physical features of a person as an authentication factor. The main drawback for biometric authentication is the privacy concerns of end-users. An end-user might not be willing and comfortable to allow banks and merchants to capture their biometric data such as a retina scan and fingerprint.
2) Security tokens—Smart cards, USB tokens, one-time-password (OTP) tokens are examples. OTP tokens have a liquid crystal display (LCD) screen which displays a pseudo-random number with 6 or more alphanumeric characters (numbers or combinations of letters and numbers, depending on the vendor and model). The pseudo-random number changes at pre-determined time intervals, usually every 60 seconds, but can also change at other time intervals or after a user event, such as the user pushing a button on the token. Tokens that change the pseudo-random number after a pre-determined time interval are referred to as time-based, and tokens that change the pseudo-random number after a user event are referred to as sequence-based (since the interval value is the current sequence number of the user events, i.e. 1, 2, 3, 4, etc.). When the pseudo-random number is combined with a personal identification number (PIN) or password, the resulting passcode has two factors of authentication (one from the PIN/password, another from the OTP token). Hybrid-tokens combine the capabilities of smartcards, USB tokens and OTP tokens.
3) Mobile Phones—two-factor authentication tools transform the user's mobile phone into a token device using SMS messaging or an interactive telephone call. The mobile phone becomes part of a two-factor, two-channel authentication mechanism. However, the SMS token device does have some operational problems and limitations, for example, an SMS OTP via mobile phone may not work properly due to being dependant on mobile phone providers, and SMS OTP may lead to increase phone bills.

However, two-factor authentication a not pervasive because of cost effectiveness. Adding the second authentication factor increases implementation and maintenance costs. Most two-factor authentication systems are proprietary and currently charge an annual fee of $50 to $100 (USD) per user. In addition, hardware token deployment is logistically challenging, hardware tokens may get damaged or lost, and hardware token issuance in large industries such as banking or even within large enterprises needs to be managed. Moreover, end users with SMS token devices also face several problems such as when a token device is forgotten, misplaced, damaged, lost or the like. Another operational limitation with SMS messaging arises when a user might not be able to receive a SMS messages overseas.

Therefore, there is a need to manage two-factor authentication that is convenient to use, requires relative low operational cost, secure to phishing site attacks and the like.

### SUMMARY

An aspect of the invention is a method of authenticating a user, comprising: providing a user key to an authentication authority; providing a transmission message from the authentication authority in response to the user key; providing a secret message using the transmission message; displaying the secret message to the user using a display screen; and providing a user response to the authentication authority in response to the user observing the secret message.

The secret message can be a pseudo-random alphanumeric code and can be part of an (m,n)-threshold secret sharing scheme, wherein m is the number of parts required to recover a secret and n is the total number parts.

The display screen can be a flat-panel display screen, an LCD screen and/or a mobile phone screen.

The user response can be the secret message.

The authentication authority can provide the user key to the user. In addition, the authentication authority can provide the transmission message to the user using the Internet, and the user can provide the user response to the authentication authority using the Internet.

The method can be a two-factor authentication scheme, wherein the user key is the first factor and the user response is the second factor.

An aspect of the invention is a method of authenticating a user, comprising providing a visual overlay from an authentication authority; providing a user key to the authentication authority; providing a background message from the authentication authority in response to the user key; displaying the background message on a display screen while the visual overlay is positioned over, aligned with and attached to the display screen; displaying a secret message to the user using the visual overlay and the background message; and providing a user response to the authentication authority in response to the user observing the secret message.

The visual overlay can include a visual matrix pattern such as a pseudo-random visual matrix pattern. The visual overlay can also include a transparent medium, wherein the visual matrix pattern is non-transparent and the visual matrix pattern is printed on the transparent medium. The authentication authority can print the visual matrix pattern on the transparent medium, or alternatively, the user can print the visual matrix pattern on the transparent medium.

The visual overlay can allow the user to observe a first selected portion of the display screen without allowing the user to observe a second selected portion of the display screen. In addition, the first selected portion of the display screen can display the secret message within the background message, the first selected portion of the display screen can be a window within the second selected portion of the display screen, the visual overlay can allow the user to observe a third selected portion of the display screen, and the user can enter the user response into the third selected portion of the display screen.

The visual overlay can be a part of an (m,n)-threshold secret sharing scheme, wherein m is the number of parts required to recover a secret and n is the total number parts. In addition, the visual overlay can have substantially the same size as the display screen.

The user response can be the secret message.

The authentication authority can provide the user key to the user and provide the visual overlay to the user in response to the user key from the user. In addition, the authentication authority can provide the background message to the user using the Internet, and the user can provide the user response to the authentication authority using the Internet.

The method can be a two-factor authentication scheme, wherein the user key is the first factor and the user response is the second factor.

An aspect of the invention is method of authenticating a user, comprising providing a user key from an authentication authority to the user; then providing the user key from the user to the authentication authority a first time; providing a visual overlay from the authentication authority to the user in response to the user key provided the first time; then providing the user key from the user to the authentication authority a second time; providing a background message from the authentication authority to the user in response to the user key provided the second time; displaying the background message on a display screen facing the user while the visual overlay is positioned over, aligned with and attached to the display screen; displaying a secret message to the user using the visual overlay and the background message; and then providing a user response from the user to the authentication authority in response to the user observing the secret message.

The encoded message can be displayed on the display screen and prompt the user to decode the encoded message, and the encoded message can be decoded in response to the user.

The secret message can be a part of an (m,n)-threshold secret sharing scheme, wherein m is the number of parts required to recover a secret and n is the total number parts.

The user response can be the secret message.

The authentication authority can provide the user key to the user. In addition, the authentication authority can provide the encoded message to the user using the Internet, and the user can provide the user response to the authentication authority using the Internet.

The method can be a two-factor authentication scheme, wherein the user key is the first factor and the user response is the second factor.

An aspect of the invention is a method of authenticating a user, comprising providing a user key to the authentication authority; encoding a secret message at the authentication authority in response to the user key, thereby providing an encoded message; providing the encoded message from the authentication authority in response to the user key; decoding the encoded message, thereby providing the secret message; displaying the secret message on a display screen to the user in response to decoding the encoded message; and providing a user response to the authentication authority in response to the user observing the secret message on the display screen.

An aspect of the invention is a method of authenticating a user, comprising providing a user key from an authentication authority to the user; then providing the user key from the user to the authentication authority; encoding a secret message at the authentication authority in response to the user key, thereby providing an encoded message; providing the encoded message from the authentication authority to the user in response to the user key from the user; displaying the encoded message on a display screen, thereby prompting the user to decode the encoded message; decoding the encoded message in response to the user observing the encoded message on the display screen, thereby providing the secret message; displaying the secret message on a display screen in response to decoding the encoded message; and providing a user response from the user to the authentication authority in response to the user observing the secret message on the display screen.

An aspect of the invention is a method of authenticating a user, comprising providing a user key to an authentication authority; providing a transmission message from the authentication authority in response to the user key; providing a secret message using the transmission message; displaying the secret message to the user using a display screen; and providing a user response to the authentication authority in response to the user observing the encrypted secret message by using a mobile phone with the decryption key.

An aspect of the invention is a method of authenticating a user, comprising providing a private key from an authentication authority; providing a user key to the authentication authority; providing a background message from the authentication authority in response to the user key; displaying the background message on a display screen while the mobile phone with the user private key is used to capture the background message on the display screen; displaying a secret message to the user using the mobile phone containing the private key and the background message; and providing a user response to the authentication authority in response to the user observing the secret message.

An aspect of the invention is a method of authenticating a user, comprising providing a user key from an authentication authority to the user; then providing the user key from the user to the authentication authority a first time; providing a private key from the authentication authority to the user in response to the user key provided the first time; then providing the user key from the user to the authentication authority a second time; providing a background message from the authentication authority to the user in response to the user key provided the second time; displaying the background message on a display screen facing the user while the mobile phone is positioned over, aligned with and capture the barcode on the display screen; displaying a secret message to the user using the mobile phone; and then providing a user response from the user to the authentication authority in response to the user observing the secret message.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1A illustrates a block diagram of a registration and key distribution process in accordance with an embodiment of the invention;

FIG. 1B is a block diagram of a server with authority system that can be used in the system in accordance with an embodiment of the invention;

FIG. 2A illustrates a block diagram of a user login process in accordance with an embodiment of the invention;

FIG. 2B is a block diagram of a computer that can be used in the system in accordance with an embodiment of the invention;

FIG. 3 illustrates a block diagram of a password reset process in accordance with an embodiment of the invention;

FIG. 4A illustrates a block diagram of a registration and mobile key distribution process in accordance with an embodiment of the invention;

FIG. 4B is a block diagram of a mobile phone that can be used in the system in accordance with an embodiment of the invention;

FIG. 5 illustrates a block diagram of a user login process in accordance with an embodiment of the invention;

FIG. 6 illustrates a key reset process in accordance with an embodiment of the invention;

FIG. 7 is a block diagram that illustrates an activation process where a private key is generated and distributed securely to the end user mobile phone;

FIG. 8 is a block diagram that illustrates a user login process in accordance with an embodiment of the invention;

FIG. 9 is a block diagram illustrating a mobile key renewal process in accordance with an embodiment of the invention; and

FIG. 10 is a block diagram illustrating a mobile key revocation process in accordance with an embodiment of the invention.

### DETAILED DESCRIPTION

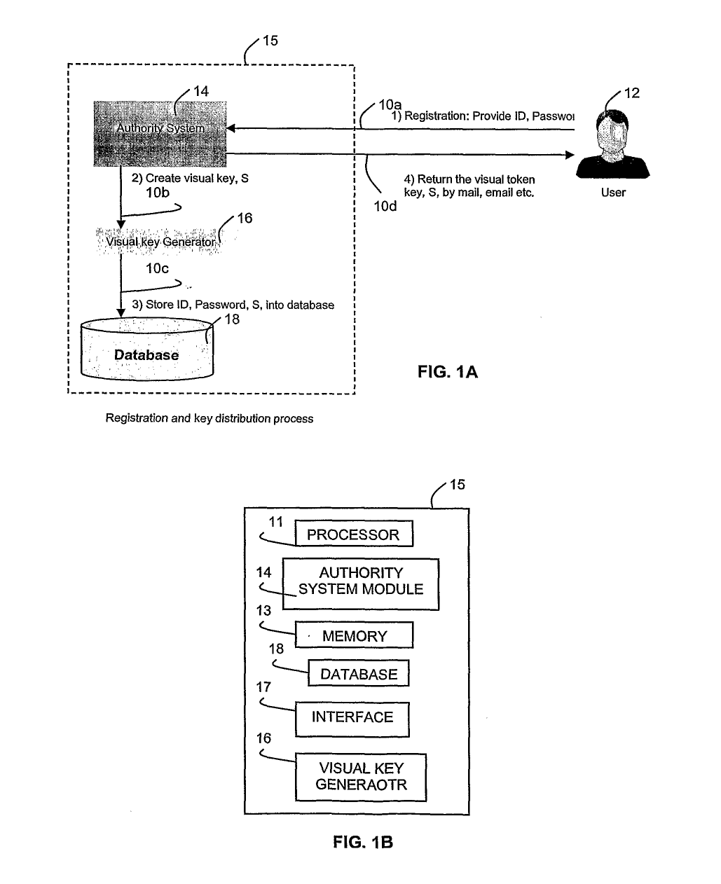

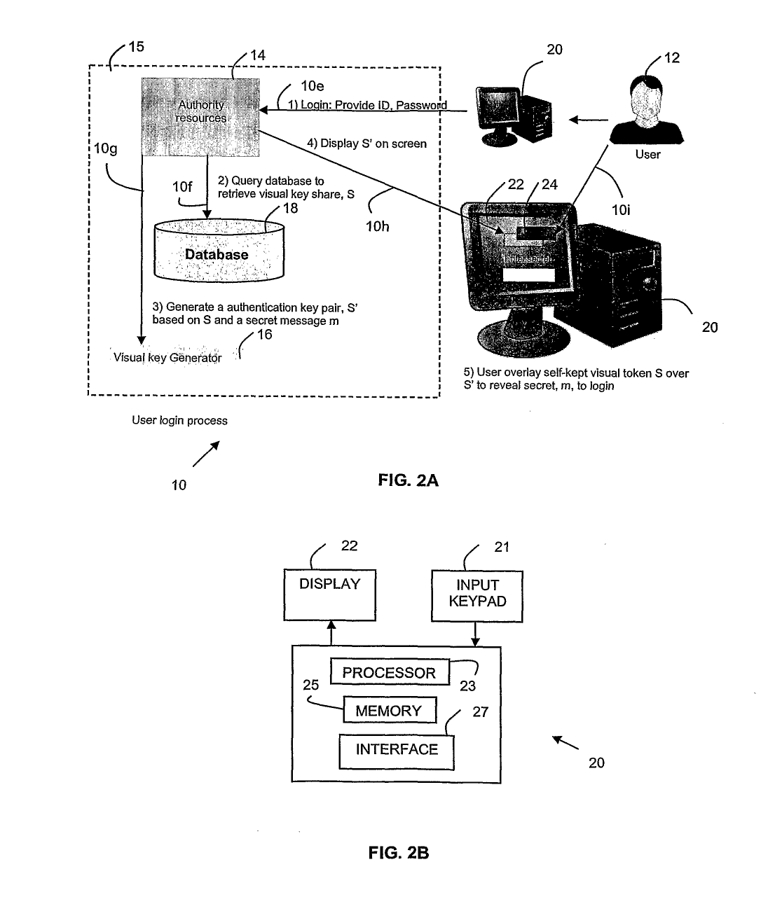

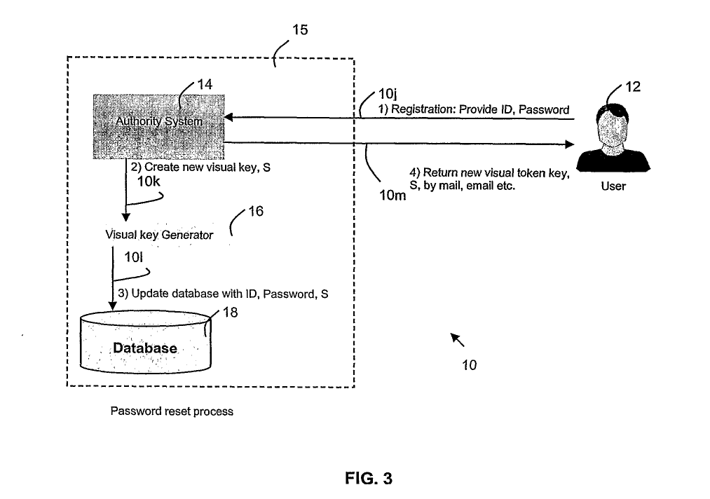

Embodiments of the invention propose a method and system that are cost effective and easy to manage two-factor authentication using the enclosed on-screen authentication methods where the “token” is essentially a pseudo-random visual matrix pattern printed on normal transparency paper using normal printing devices. FIG. 1-3 show block diagrams illustrating the registration and key distribution (FIG. 1), the user login process (FIG. 2), and the password reset process (FIG. 3) in accordance with an embodiment of the invention. An embodiment of the invention is a technique that is different from typical tokens solution in that it can be use for secure multi-party login. Another embodiment of the invention is a mobile phone based application.

Secret sharing scheme is a well researched area in cryptography proposed by Naor, M. and Shamir, A., “Visual cryptography”, In: LNCS, vol. 950, Springer-Verlag. pp. 1-12, incorporated herein by reference. The motivation for secret sharing is secure key management. In some situations, there is usually one secret key that provides access to many important files. If such a key is lost (e.g., the person who knows the key becomes unavailable, or the computer which stores the key is destroyed), then all the important files become inaccessible. The basic idea in secret sharing is to divide the secret key into pieces and distribute the pieces to different persons so that certain subsets of the persons can get together to recover the key.

The general model for secret sharing is called an m-out-of-n scheme (or (m, n)-threshold scheme) for integers 1, m, and n. In the scheme, there is a sender (or dealer) and n participants. The sender divides the secret into n parts and gives each participant one part so that any m parts can be put together to recover the secret, but any m−1 parts reveal no information about the secret. The pieces are usually called shares or shadows. Different choices for the values of m and n reflect the tradeoff between security and reliability. A secret sharing scheme is perfect if any group of at most m−1 participant (insiders) has no advantage in guessing the secret over the outsiders. Therefore in a single party authentication mode, it is a (2, 2)-threshold scheme. In practice, the hidden secret could be any colored image which contains any graphics or characters from any language. This secret will be required as a second factor authentication during user login.

With the reduction of cost in flat-screen display devices like LCD, Plasma TV, flat-screen CRT, and even mobile devices, it is becoming more pervasive items.

Embodiments of the invention may include different schemes for effective and secured T-FA, for example by visual codes overlay, mobile token authentication, or the like.

In an embodiment, the proposed scheme by visual codes overlay can be described in main phases: 1) registration and key distribution to users, 2) online user login and 3) password reset.

For phase 1 as shown in FIG. 1A, the authority 14 for online resources, for example a bank which provides Internet banking services, first needs to register and distribute a random key share to a user 12. The server 15 is of the authority 14 is shown by dashed box, however, it will be appreciated that the components shown of authority system 14, visual key generator 16 and database 18 may take different configurations, for example may be located remotely or separate from each other. Typically, the user provides registration information 10a such as identification, password and the like, and will be given a generated user ID and password generated by a key generator 16 and on top of that, the secret key shares printed on a transparent, physical medium (transparency) 24. The visual key, S, is created 10b and with the visual key generator the store ID, password, S, etc. is stored 10c in the database 18. This key could be sent 10d to the user through registered mail or even by electronic form for self-printing. The authority will keep a database 18 of all the user information: user ID|Password|key share. FIG. 1B is a block diagram of a server 15 with authority system module 14 that can be used in the system in accordance with an embodiment of the invention. The server may have a processor 11, memory 13, database 18, interface 17, visual key generator 16 and the like. It will be appreciated that the components shown in the server are for illustrative purposes and may take different arrangements and configurations, for example components such as the database, etc. may be located separately and/or remotely from the server.

For phase 2, as shown in system 10 of FIG. 2A, when a user 12 tries to access online resources, the authority 14 will prompt 10e the user for user ID and password. Once this information is verified be correct, the system from the authority will generate 10g a pseudo-random share, S, based on a secret message will be displayed 10h as S on the screen and the user key share so that when the user overlays 10h,10i the user's self-kept visual token on the screen 22 over the secret message on the user's computer 20 on top of S, the secret message will be revealed. The database 18 is queried 10f to retrieve visual key share, S. The user then needs to key in this secret message and if it is correct, the user can gain access to the online resource. For multi-party login, at least n users need to be present with their key shares to overlay 24 and reveal the secret message before they can login. FIG. 2B is a block diagram of a computer 20 that can be used in the system in accordance with an embodiment of the invention. The computer is illustrative and may include processor 23, memory 25, interface 27 for interconnecting and communicating with other components of the system and the display 22 and input 21 such as a keyboard or keypad.

For Phase 3, as shown in FIG. 3, in the case of compromise or loss of the end-user secret token, the end-user could easily do a password reset with the authority. Basically, the end-user 12 will register 10j with the authority and ask for a new token. Authority system 14 will process the request and re-generate 10k with the key generator 16 a new visual key and update 10l the user ID|Password|key share entry in the database 18. The new key can be convenient distributed 10m to the end user via registered mail, email etc.

Due to the variants of display devices at the user's end, it may be difficult for end-user to align and overlay lens against the display screen to correctly display the secret message during authentication. To tackle this, an embodiment of the invention includes a few proposed techniques for easy on-screen authentication, for example:

Technique 1: Easily adjustable on-screen lens size for end users
Technique 2: Redundancy in secret message structure
Technique 3: Dynamic screen size matching program
Technique 4: Pre-printed multi-size lens key

By using the lens key as a token, there are several advantages over traditional tokens solution, for example:
1) Each lens key cost much less than a physical token
2) Lens key could be easy distributed to the end-user for self printing.
3) In case of any compromise to the lens key, a renewal key could be easily generated and distributed to the affected user.

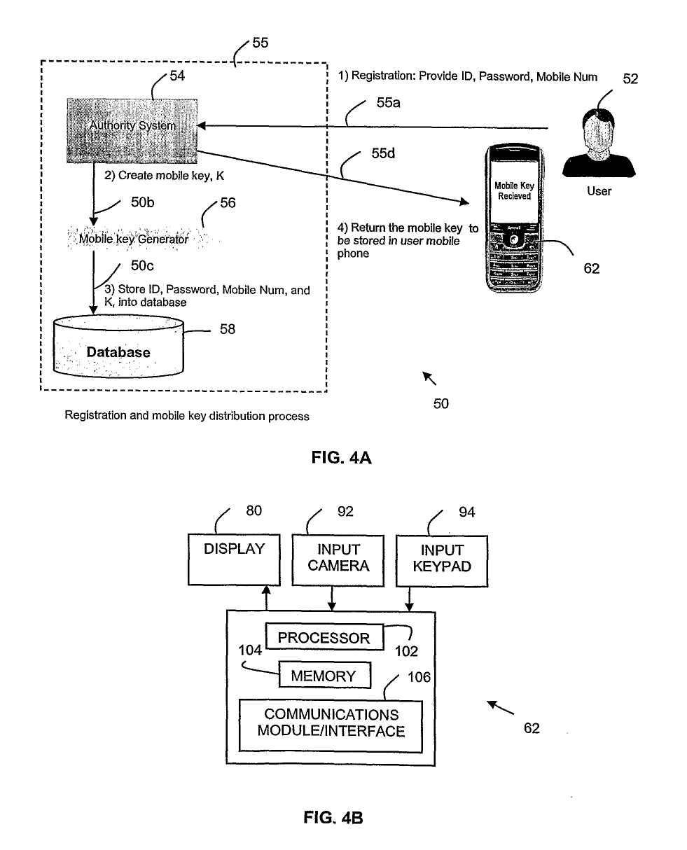

In an embodiment, the proposed scheme by mobile token authentication can be described in main phases: 1) user registration and mobile key distribution, 2) user login and authentication and 3) mobile key reset. FIG. 4-10 provide another embodiment having a similar process for mobile token authentication. The system 50 of FIG. 4 shows a server 55 of the authority 54 is shown by dashed box, however, it will be appreciated that the components shown of authority system 54, mobile key generator 56 and database 58 may be in different configurations, for example located remotely or separate from each other. In this way, the user 52 provides 55a to the authority system 54 registration information such as ID, password, mobile number and the like. The mobile key generator 56 creates 50b mobile key, K. The registration information and mobile key K is stored 50c in database. The mobile key is then returned 50d via authority system 54 to be stored in the user's mobile phone. FIG. 4B is a block diagram of a mobile phone 62 that can be used in the system in accordance with an embodiment of the invention. The mobile phone 62 shown is illustrative and may comprise a processor 102, memory 104 and an interface 106 and communications module for interacting and intercommunicating with other components of the system and display 80, input 92 such as a camera, input 94 such as a keyboard or keypad, and other like components.

In order for the mobile key to be transmitted securely (either via SMS, GPRS or any form of transportation protocol), it will be encrypted prior to the transmission. The encryption can be done either via a symmetric key algorithm or based on public key infrastructure (PKI) key-pairs. When a PKI system is used, the contents embedded in the visual code may be encrypted and digitally signed using the public and private keys of the authority system 54. In this way, a 2-way verification of the service provider and service requestor can be ascertained securely, thereby increasing the security of the whole system.

Similarly, the mobile key generated can either be based on a symmetric key algorithm or based on public key infrastructure (PKI) key-pairs.

In cases where the user 52 needs to authenticate with more than one authority systems 54, the same mobile application installed on his mobile phone can be used. In this case, multiple mobile keys specific to each of the authority systems would be stored securely on the mobile phone. The mobile key generator 56 creates new mobile key, K.

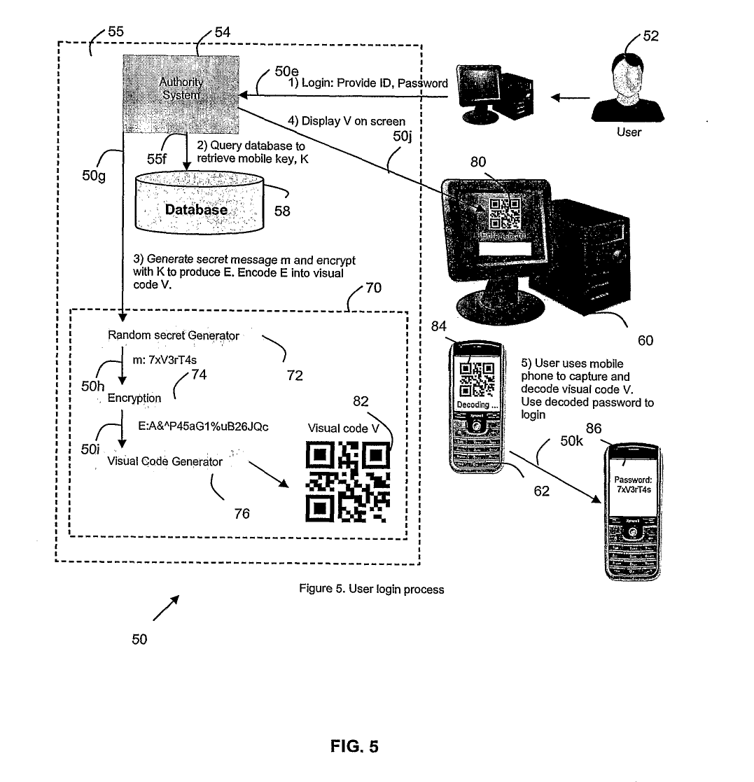

The system 50 shown in FIG. 5 shows authority system 54 with database 58 and random secret and visual code generator 70 having random secret generator module 72, encryption module 74, and visual code generator module 76 for producing visual code V 82. The user 52 logins 50e via a computer 60 with ID, password and the like, and the database is queried 50f database 58 to retrieves mobile key, K, where the secret message m is generated 50g and encrypted with K to produce E as shown in FIG. 5. Encoded E is generated 50h,50i into visual code V 82. The visual code V is displayed on screen 80 of computer and the user 52 uses a mobile device 62 to capture and decode visual code V to display 50j on mobile device visual code 84 on display of mobile device and of password 86 on display. The user uses 55k decoded password to login.

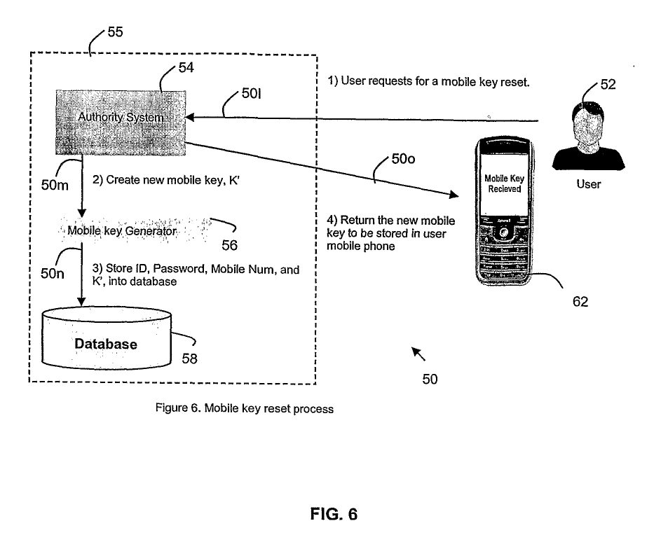

FIG. 6 shows the process flow of the mobile key reset process of the system. The user 52 requests 501 for a mobile key reset. The authority creates 50m a new mobile key K. The store ID and other information such as ID, password, mobile number, K, and the like is stored 50n into the database 58. The new mobile key is returned 50o via authority system 54 to be stored in user mobile phones.

Visual lens or user overlay 24 is comparatively easier to replicate than physical tokens and it will be appreciated that the visual lens is more cost effective.

An embodiment of the invention could be used as authentication means for scenario with these important characteristics: cross-order and mass authentication.

Market segments and/or applications of embodiments of the invention in regards to two-factor authentication may include enterprise applications such as secure remote access, enterprise authentication, business to business (B2B) transactions, or the like; consumer applications such as online banking, electronic commerce, ISPs, or the like; government applications such as common authentication or the like.

An embodiment of the invention is a technique that is different from typical tokens solution in that it can be use for secure login.

In an embodiment, public-key cryptography is a method employed for secret communication between two parties without requiring an initial exchange of secret keys. It can also be used to create digital signatures. Public key cryptography enables secure transmission of information on the Internet.

It is also known as asymmetric key cryptography because the key used to encrypt a message differs from the key used to decrypt it. In public key cryptography, a user has a pair of cryptographic keys—a public key and a private key. The private key is kept secret, while the public key may be widely distributed. Messages are encrypted with the recipient's public key and can only be decrypted with the corresponding private key. The keys are related mathematically, but the private key cannot be feasibly (ie, in actual or projected practice) derived from the public key.

Symmetric cryptography uses a single secret key for both encryption and decryption. To use a symmetric encryption scheme, the sender and receiver must share a key in advance. Because symmetric encryption is less computationally intensive and requires less bandwidth, it is common to exchange a key using a key-exchange algorithm and transmit data using an enciphering scheme.

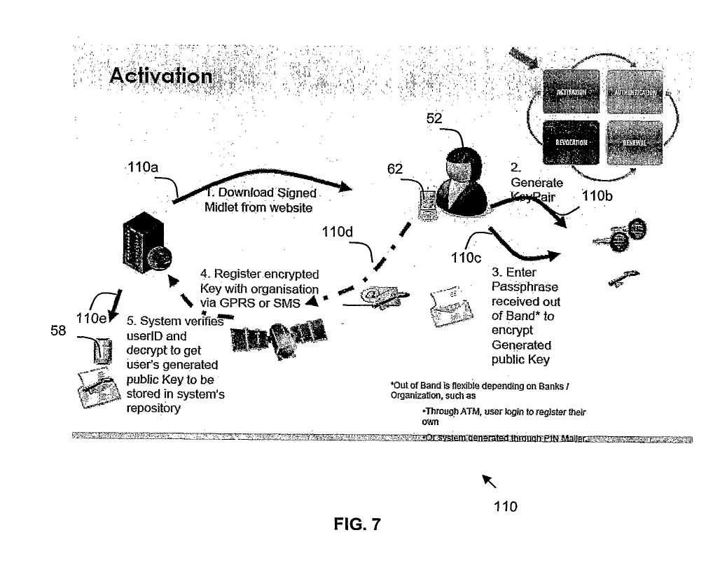

FIG. 7 is a block diagram that illustrates an activation process 110 where a private key is generated and distributed securely to the end user 52 mobile phone 62. The activation process involves downloading 110a signed midlet from website and generating 110b key pair. The passphrase is entered 110c that is received out of band to encrypt generated public key, where out of band is flexible depending on banks, other organizations and the like, through for example the ATM, user login to register their own or system automatically generated. The encrypted key is registered 110d with organization via GPRS, SMS, or the like. The system verifies user ID and decrypted to get user's generated public key that is to be stored 110e in the system's repository.

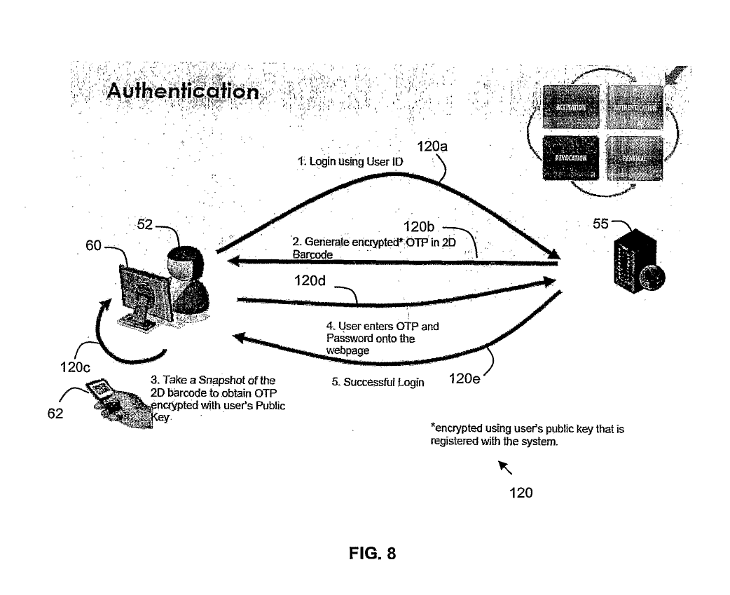

FIG. 8 is a block diagram that illustrates a user login process 120 in accordance with an embodiment of the invention. The authentication process involves the user login 120a to the system, for example at server 55, with login or registration information. The encrypted OTP is generated 120b in 2D barcode format for example. The system encrypts using the user's public key that is registered with the system. The user with image capturing device such as camera 94 on mobile phone 62 to take a snapshot 120c of the 2D bar to obtain OTP encrypted with the user's public key. The user 52 enters 120d the OTP and password onto the webpage, for example, and successfully logs in 120e.

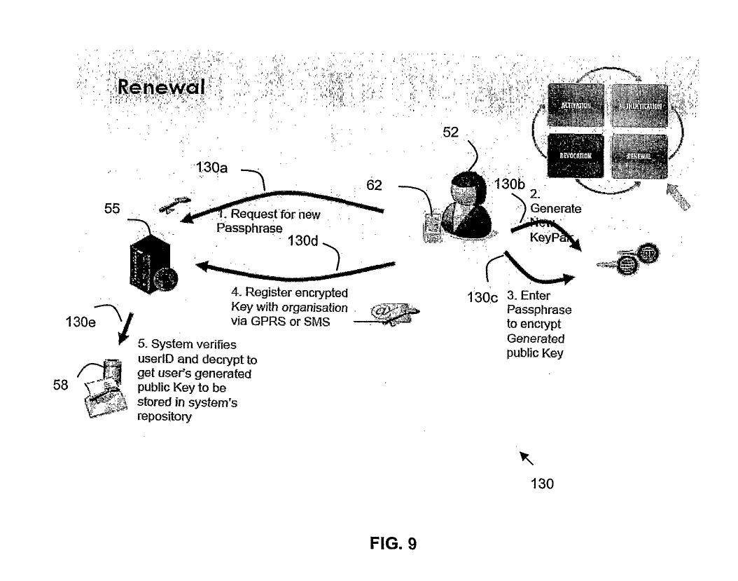

FIG. 9 is a block diagram illustrating a mobile key renewal process 130 in accordance with an embodiment of the invention. A user 52 requests 130a for new passphrase, and a new key pair is generated 130b. The passphrase is entered 130c to encrypt and generate the public key. The encrypted key is registered 130d with organisations for example via GPRS, SMS or the like. The system verifies the user ID and decrypts to obtain the user's generated public key and then stores 130e in the system's repository.

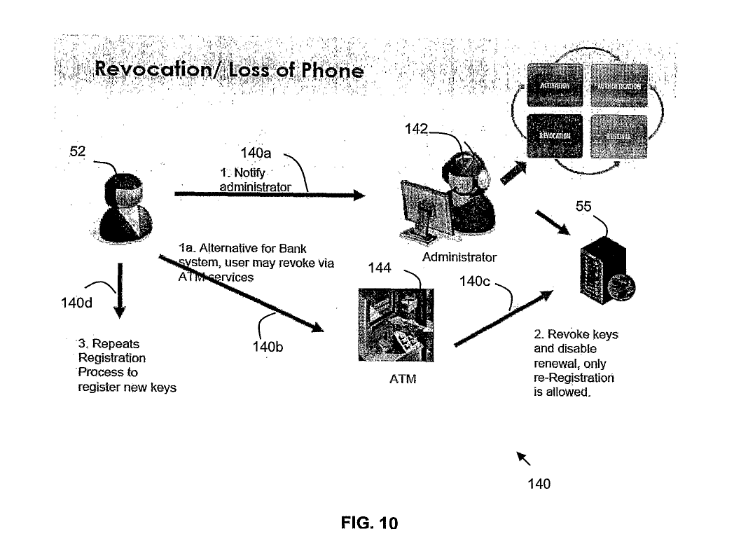

FIG. 10 is a block diagram illustrating a mobile key revocation or loss of phone process 140 in accordance with an embodiment of the invention. The user 52 notifies 140a the administrator 142. In another embodiment the user revokes 140b using other means such as automatic teller machines (ATM). The keys are revoked 140c by system 55 and renewal is disabled. In an embodiment, only re-registration is allowed. The user 32 repeats 140d registration process to register new keys.

While embodiments of the invention have been described and illustrated, it will be understood by those skilled in the technology concerned that many variations or modifications in details of design or construction may be made without departing from the present invention.

1. A method of authenticating a user, comprising:
providing a user key to an authentication authority;
providing a transmission message from the authentication authority in response to the user key;
providing a secret message using the transmission message;
displaying the secret message to the user using a display screen; and
providing a user response to the authentication authority in response to the user observing the secret message.

2. The method of claim 1, wherein the secret message is a pseudo-random alphanumeric code.

3. The method of claim 1, wherein the secret message is a part of an (m,n)-threshold secret sharing scheme, m is the number of parts required to recover a secret and n is the total number parts.

4. The method of claim 1, wherein the display screen is a flat-panel display screen.

5. The method of claim 1, wherein the display screen is an LCD screen.

6. The method of claim 1, wherein the display screen is a mobile phone screen.

7. The method of claim 1, wherein the user response is the secret message.

8. The method of claim 1, wherein the authentication authority provides the user key to the user.

9. The method of claim 1, wherein the authentication authority provides the transmission message to the user using the Internet, and the user provides the user response to the authentication authority using the Internet.

10. The method of claim 1, wherein the method is a two-factor authentication scheme, the user key is the first factor and the user response is the second factor.

11. A method of authenticating a user, comprising:
providing a visual overlay from an authentication authority;
providing a user key to the authentication authority;
providing a background message from the authentication authority in response to the user key;
displaying the background message on a display screen while the visual overlay is positioned over, aligned with and attached to the display screen;
displaying a secret message to the user using the visual overlay and the background message; and
providing a user response to the authentication authority in response to the user observing the secret message.

12. The method of claim 11, wherein the visual overlay includes a visual matrix pattern.

13. The method of claim 11, wherein the visual overlay includes a pseudo-random visual matrix pattern.

14. The method of claim 11, wherein the visual overlay includes a visual matrix pattern and a transparent medium, the visual matrix pattern is non-transparent and the visual matrix pattern is printed on the transparent medium.

15. The method of claim 11, wherein the visual overlay includes a pseudo-random visual matrix pattern and a transparent medium, the pseudo-random visual matrix pattern is non-transparent and the pseudo-random visual matrix pattern is printed on the transparent medium.

16. The method of claim 14, wherein the authentication authority prints the visual matrix pattern on the transparent medium.

17. The method of claim 14, wherein the user prints the visual matrix pattern on the transparent medium.

18. The method of claim 16, wherein the authentication authority prints the pseudo-random visual matrix pattern on the transparent medium.

19. The method of claim 16, wherein the user prints the pseudo-random visual matrix pattern on the transparent medium.

20. The method of claim 11, wherein the visual overlay allows the user to observe a first selected portion of the display screen without allowing the user to observe a second selected portion of the display screen, and the first selected portion of the display screen displays the secret message within the background message.

21. The method of claim 20, wherein the first selected portion of the display screen is a window within the second selected portion of the display screen.

22. The method of claim 21, wherein the visual overlay allows the user to observe a third selected portion of the display screen, and the user enters the user response into the third selected portion of the display screen.

23. The method of claim 11, wherein the visual overlay is a part of an (m,n)-threshold secret sharing scheme, m is the number of parts required to recover a secret and n is the total number parts.

24. The method of claim 11, wherein the visual overlay is substantially the same size as the display screen.

25-27. (canceled)

28. The method of claim 11, wherein the authentication authority provides the user key to the user, and the authentication authority provides the visual overlay to the user in response to the user key from the user.

29. The method of claim 11, wherein the authentication authority provides the background message to the user using the Internet, and the user provides the user response to the authentication authority using the Internet.

30. (canceled)

31. The method of claim 11 further comprising:
providing the user key from the authentication authority to the user; then
providing the user key from the user to the authentication authority a first time;
providing a visual overlay from the authentication authority to the user in response to the user key provided the first time; then
providing the user key from the user to the authentication authority a second time;
providing the background message from the authentication authority to the user in response to the user key provided the second time;
displaying the background message on a display screen facing the user while the visual overlay is positioned over, aligned with and attached to the display screen;
displaying a secret message to the user using the visual overlay and the background message; and then
providing a user response from the user to the authentication authority in response to the user observing the secret message.

32-40. (canceled)

41. A method of authenticating a user, comprising:
providing a user key to the authentication authority;
encoding a secret message at the authentication authority in response to the user key, thereby providing an encoded message;
providing the encoded message from the authentication authority in response to the user key;
decoding the encoded message, thereby providing the secret message;
displaying the secret message on a display screen to the user in response to decoding the encoded message; and
providing a user response to the authentication authority in response to the user observing the secret message on the display screen.

42-50. (canceled)

51. The method of claim 41, wherein:
providing the user key from the authentication authority to the user; then
providing the user key from the user to the authentication authority;
encoding the secret message at the authentication authority in response to the user key, thereby providing the encoded message;
providing the encoded message from the authentication authority to the user in response to the user key from the user;
displaying the encoded message on a display screen, thereby prompting the user to decode the encoded message;
decoding the encoded message in response to the user observing the encoded message on the display screen, thereby providing the secret message;
displaying the secret message on a display screen in response to decoding the encoded message; and
providing a user response from the user to the authentication authority in response to the user observing the secret message on the display screen.

52-60. (canceled)

61. The method of claim 1 further comprising:
providing a user response to the authentication authority in response to the user observing the encrypted secret message by using a mobile phone with the decryption key.

62-70. (canceled)

71. A method of authenticating a user, comprising:
providing a private key from an authentication authority;
providing a user key to the authentication authority;
providing a background message from the authentication authority in response to the user key;
displaying the background message on a display screen while a mobile phone with the user private key is used to capture the background message on the display screen;
displaying a secret message to the user using the mobile phone containing the private key and the background message; and
providing a user response to the authentication authority in response to the user observing the secret message.

72. The method of claim 71, wherein the private key is generated as a private-public key pair by the authentication authority.

73. The method of claim 71, wherein the private key is downloaded to the user as a Midlet.

74. The method of claim 71, wherein the private key is downloaded to the user as a Midlet and installed into the user mobile phone.

75. The method of claim 71, wherein the private key is downloaded to the user as a Midlet and installed into the user mobile phone and is linked to a barcode capture application.

76. The method of claim 74, wherein the authentication authority generates a private-public key for the user during registration.

77. The method of claim 74, wherein the user downloads the Midlet.

78. The method of claim 76, wherein the authentication sends the private key to the user as a Midlet.

79. The method of claim 76, wherein the user installs the Midlet onto a mobile phone.

80. The method of claim 71, wherein the mobile phone with the private key allows the user to observe a first selected portion of the display screen without allowing the user to observe a second selected portion of the display screen, and the first selected portion of the display screen displays the secret message encrypted and stored in a barcode.

81. The method of claim 80, wherein the first selected portion of the display screen is a window within the second selected portion of the display screen.

82. The method of claim 81, wherein the mobile phone with the private key allows the user to observe a third selected portion of the display screen, and the user enters the user response into the third selected portion of the display screen.

83. The method of claim 71, wherein the private key is a part of private-public key pair generated by the authentication authority required to recover a secret message.

84-90. (canceled)

91. The method of claim 71 further comprising:
providing the user key from the authentication authority to the user; then
providing the user key from the user to the authentication authority a first time;
providing the private key from the authentication authority to the user in response to the user key provided the first time; then
providing the user key from the user to the authentication authority a second time;
providing a background message from the authentication authority to the user in response to the user key provided the second time;
displaying the background message on a display screen facing the user while a mobile phone is positioned over, aligned with to capture the background message on the display screen;
displaying a secret message to the user using the mobile phone; and then
providing a user response from the user to the authentication authority in response to the user observing the secret message.

92-100. (canceled)

101. The method of claim 41, wherein the secret message is an encrypted message encoded in a barcode.

102. The method of claim 41, wherein the private key is a part of a private-public key pair required to recover a secret message.
